(19) United States
(12) Patent Application Publication
(10) Pub. No.: US 2026/0340095 A1
(43) Pub. Date: Oct. 29, 2026

(54) USER AUTHENTICATION USING SUBSCRIBER IDENTITY MODULE (SIM) AND BIOMETRICS

(71) Applicant: Boost SubscriberCo L.L.C., Englewood, CO (US)

(72) Inventors: Dale Drew, Arvada, CO (US); Matthew Kniess, III, Lakewood, CO (US)

(21) Appl. No.: 19/187,450

(22) Filed: Apr. 23, 2025

(51) Int. Cl. G06F 21/32

(52) U.S. Cl. CPC G06F 21/32

(57) ABSTRACT

A user of a biometric device is authenticated by a cellular network to grant access to an application based authentication credentials of the user. The authentication credentials include a unique identifier of a subscriber identity module (SIM) of the biometric device and biometric data of the user. An active session of the computing resource is established responsive to successful authentication. The active session of the computing resource is managed responsive to receiving a subsequent authentication credentials during the active session of the computing resource.

### BACKGROUND

With the emergence of extended reality (XR) technologies, encompassing both augmented reality (AR) and virtual reality (VR), users increasingly need secure access to applications that control and manage their digital assets and rights. These XR technologies have seen accelerated adoption due to improvements in hardware capabilities and communication technologies, such as fifth generation (5G) new radio (NR) cellular networks offering ultra-reliable low latency communications.

In current implementations, XR device users follow a multi-step authentication process to access applications. First, the user provides biometric data, which the XR device validates against a locally stored biometric hash. After successful validation, the device sends an access request through the internet to the application. The application responds with an authentication key, which the device verifies to establish an authenticated session. However, this internet-dependent authentication process introduces unnecessary latency and overhead for XR application access.

Furthermore, a significant security vulnerability exists if the original authenticated user removes the XR device or steps away, the session remains active. This allows anyone who physically accesses the unattended device to use the original user's authenticated session. While the initial biometric validation and application authentication successfully establish the session, the system lacks continuous verification to ensure the original authenticated user maintains active control of the XR device.

### BRIEF DESCRIPTION OF THE DRAWINGS

The present disclosure is illustrated by way of example, and not by way of limitation, in the figures of the accompanying drawings.

FIG. 1 is a block diagram of a system implementing continuous user authentication using SIM and biometrics in a cellular network for an application according to at least one embodiment.

FIGS. 2 and 3 are block diagrams of systems including user authentication component implements continuous user authentication using SIM and biometrics in the cellular network for the application according to at least one embodiment.

FIG. 4 is a block diagram of the user authentication component that implements user authentication using SIM and biometrics in the cellular network for the application according to at least some embodiments.

FIG. 5 is a sequence diagram illustrating a method of implementing user authentication using SIM and biometrics in the cellular network for the application according to at least one embodiment.

FIG. 6 is a flow diagram of an example method of implementing user authentication using SIM and biometrics in the cellular network for the application according to at least one embodiment.

### DETAILED DESCRIPTION

Aspects and embodiments of the present disclosure address the above and other deficiencies by performing continuous user authentication using SIM and biometrics in the cellular network for a computing resource. Unlike conventional approaches that authenticate the user device once after requesting access to the computing resource, such as an application, a service, a virtual or physical infrastructure, as previously described, logic positioned at a network edge of a cellular network provides continuous user authentication using SIM and biometrics thereby improving security and performance of the computing resource. In particular, a current user of a user device (e.g., a registered user of the user device or a non-registered user of the user device) may request access to the computing resource on a user device, such as a biometric-enabled user device.

The SIM of the user device may be configured to facilitate network connectivity and access to services. SIM refers to any form of technology, including physical SIM, embedded SIM (eSIM), integrated SIM (iSIM), or virtual SIM (vSIM), that securely stores a network identifier and information required for accessing the cellular network (or network) of a communication service provider (CSP). CSP refers to any entity, including mobile network operators (MNOs) and mobile virtual network operators (MVNOs), that provides network connectivity and related services to devices. The network identifier may be a unique value, such as the subscription concealed identifier (SUCI), that may conceal the international mobile subscriber identity (IMSI), which may be a subscription permanent identifier (SUPI) associated with a specific SIM on the CSP's network.

The biometric-enabled user device captures biometric data of the user and converts it into a biometric hash. In some embodiments, the computing resource may be hosted on or near the network edge. The biometric-enabled user device provides, via the secure communication channel, the session identifier of the SIM and the biometric hash of the current user (e.g., the received biometric hash) to the network edge. The network edge includes radio access infrastructure and edge resources enabling network access and local processing capabilities. The logic authenticates the current user by comparing the received biometric hash of the current user to a biometric hash of the registered user associated with the SIM. The registered user corresponds to a subscriber that provisioned, activated, and registered the SIM of their device (e.g., the user device). Biometrics of the registered user, represented as the biometric hash of the registered user, is associated with the SIM of the subscriber.

In response to the received biometric hash matching the biometric hash of the registered user associated with the SIM, granting the current user access to the computing resource and establishing an active session with the computing resource. Otherwise, the current user is denied access to the computing resource indicating that a non-registered user is requesting access to the computing resource on the biometric-enabled user device.

During the active session with the computing resource, the logic continuously authenticates the current user to manage the active session with the computing resource. In some embodiments, the logic may terminate the active session with the computing resource when the logic does not receive a biometric hash of the current user (indicating that the current user is no longer present) or when a biometric hash of the current user does not match the biometric hash of the registered user associated with the SIM (indicating that the current user is now a non-registered user). Otherwise, the logic maintains the active session with the computing resource (indicating that the current user is still the registered user). Since the biometric hash is linked to the SIM, moving the SIM to another device does not affect authentication of the registered user of the SIM.

Aspects and embodiments of the present disclosure can provide an improved security by continuously authenticating users based on their biometrics and registered SIM. Additional benefits can be achieved, such as improved performance through latency reduction, by hosting the authentication process and computing resources requiring user authentication at the network edge instead of the public internet.

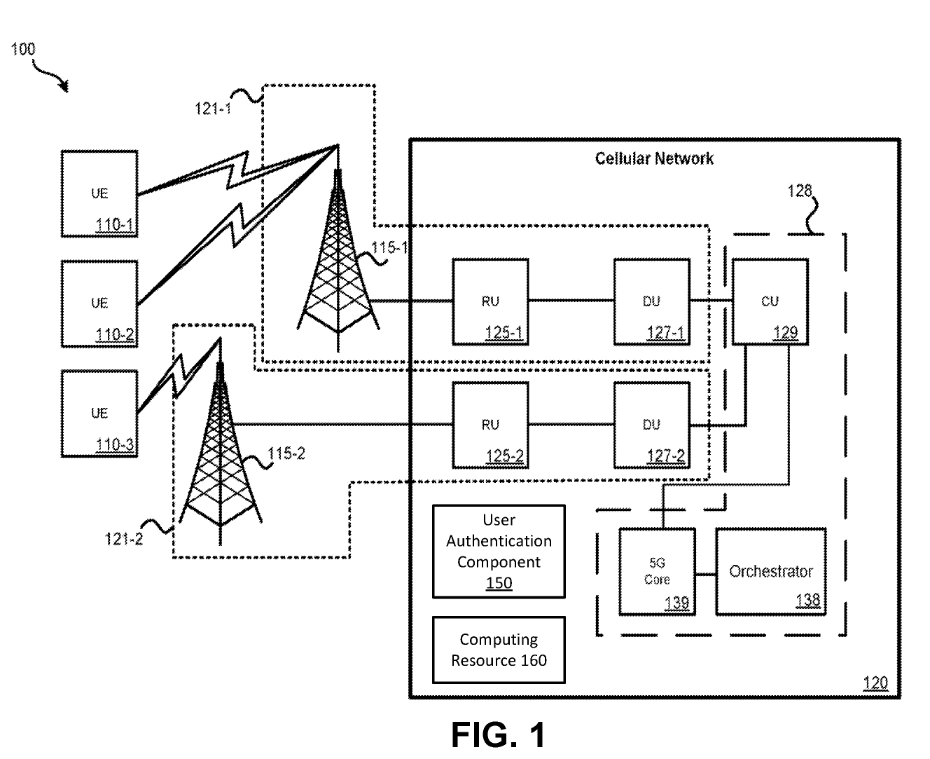

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as XR device, cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Additionally, UE can represent any type of device that captures biometric data, such as fingerprint scanners, facial recognition cameras, and iris/retinal scanners used for secure authentication. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. When UEs connect to the network, their traffic is routed to specific Data Network Names (DNNs) in 5G networks (the evolution of 4G's Access Point Names or APNs). For instance, high-priority data sent by a UE may be associated with a specific DNN and mapped to a network slice layer having relatively higher QoS parameters, while lower-priority data might be routed through a different DNN to a layer with less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF) (e.g., NSSF 338). NRF can allow 5G network functions (NFs) to register and discover each other via a standards-based application programming interface (API). NSSF can be used by access and mobility management function (AMF) (e.g., AMF 334) to assist with the selection of a network slice that will serve a particular UE.

Policy management components can include charging function (CHF) and policy control function (PCF) (e.g., PCF 335). CHF allows charging services to be offered to authorized network functions. Converged online and offline charging can be supported. PCF allows for policy control functions and the related 5G signaling interfaces to be supported.

Subscriber management components can include UDM (e.g., UDM 336) and authentication server function (AUSF) (e.g., AUSF 337). UDM can allow for generation of authentication vectors, user identification handling, NF registration management, and retrieval of UE individual subscription data for slice selection. AUSF performs authentication with UE.

Packet control components can include access and mobility management function (AMF) (e.g., AMF 334) and session management function (SMF) (e.g., SMF 333). AMF can receive connection- and session-related information from UE and is responsible for handling connection and mobility management tasks. SMF is responsible for interacting with the decoupled data plane, creating updating and removing protocol data unit (PDU) sessions, and managing session context with the user plane function (UPF) (e.g., manage UE context and network handovers between base stations).

User plane function (UPF) (e.g., UPF 232) can be responsible for packet routing and forwarding, packet inspection, QoS handling, and external PDU sessions for interconnecting with a data network (DN) (e.g., DN 380) (e.g., the Internet) or various access networks. Access networks can include the RAN of cellular network 120.

The SMF 333 may configure or control the UPF 232 via the N4 interface. For example, the SMF 333 may control packet forwarding rules used by the UPF 232 and adjust QoS parameters for QoS enforcement of data flows (e.g., limiting available data rates). In some cases, multiple SMF/UPF pairs may be used to simultaneously manage user plane traffic for a particular user device, such as UE 210. For example, a set of SMFs may be associated with UE 210, where each SMF of the set of SMFs corresponds with a network slice. The SMF 333 may control the UPF 232 on a per end user data session basis, in which the SMF 333 may create, update, and remove session information in the UPF 232.

Decoupling control signaling in the control plane from user plane traffic in the user plane may allow the UPF 232 to be positioned in close proximity to the edge of a network compared with the AMF 334. As a closer geographic or topographic proximity may reduce the electrical distance, the electrical distance from the UPF 232 to the UE 210 may be less than the electrical distance of the AMF 334 to the UE 210.

5G core 139 may reside on a cloud computing platform. While from a client’s or user’s point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

In some embodiments, the cellular network 120 includes a user authentication component 150 that implements continuous user authentication using SIM and biometrics in the cellular network for a computing resource 160. In some embodiments, the user authentication component 150 is part of the base station(s). In some embodiments, the user authentication component 150 is part of the 5G core 139. Further details regarding the operations of the user authentication component 150 are described below with reference to FIGS. 1, 2, and 4.

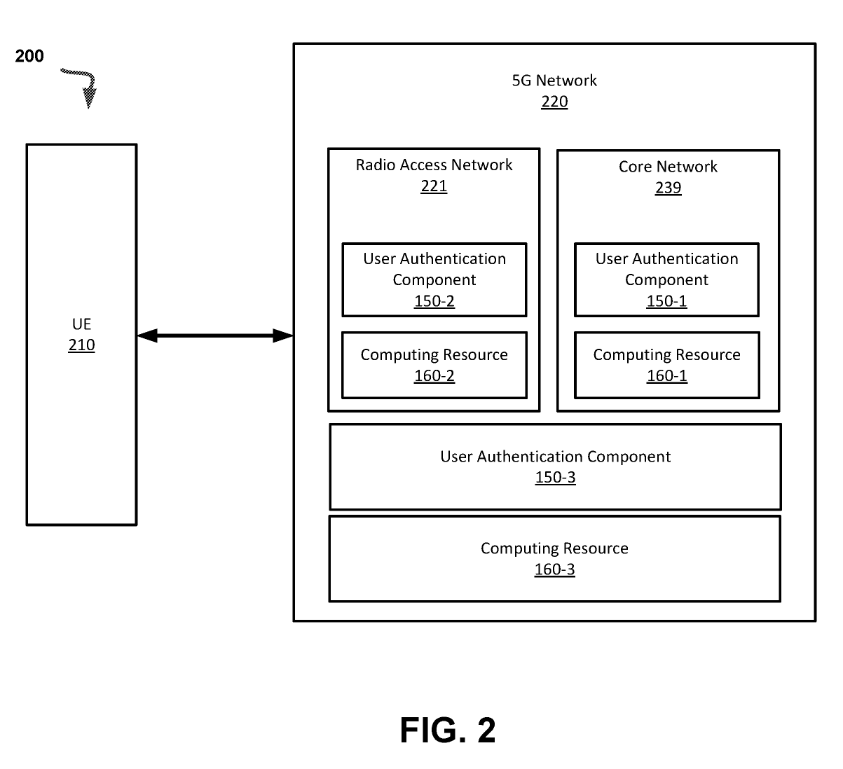

FIG. 2 is a block diagram of example of a system 200, similar to system 100 of FIG. 1, that includes a user authentication component that implements continuous user authentication using SIM and biometrics in the cellular network for the computing resource according to at least one embodiment. Referring to FIG. 2, a 5G network 220 includes a radio access network (RAN) 221 and a core network 239 according to at least one embodiment. In at least one embodiment, a user authentication component (e.g., user authentication component 150-3) and a computing resource (e.g., computing resource 160-3) can be implemented in the 5G network 220. In at least one embodiment, a user authentication component (e.g., user authentication component 150-2) and a computing resource (e.g., computing resource 160-2) can be implemented in the RAN 221. In at least one embodiment, a user authentication component (e.g., user authentication component 150-1) and a computing resource (e.g., computing resource 160-1) can be implemented in the core network 239. In at least one embodiment, each of user authentication component 150-1, 150-2, 150-3 can independently perform the operations described herein. In at least one embodiment, a combination of any of user authentication component 150-1, 150-2, 150-3 can coordinately perform the operations described herein. In at least one embodiment, user authentication component 150 described in FIGS. 1-5 can be the same to one or more of user authentication component 150-1, 150-2, 150-3. In at least one embodiment, computing resource 160 described in FIGS. 1-5 can be the same to one or more of computing resource 160-1, 160-2, 160-3.

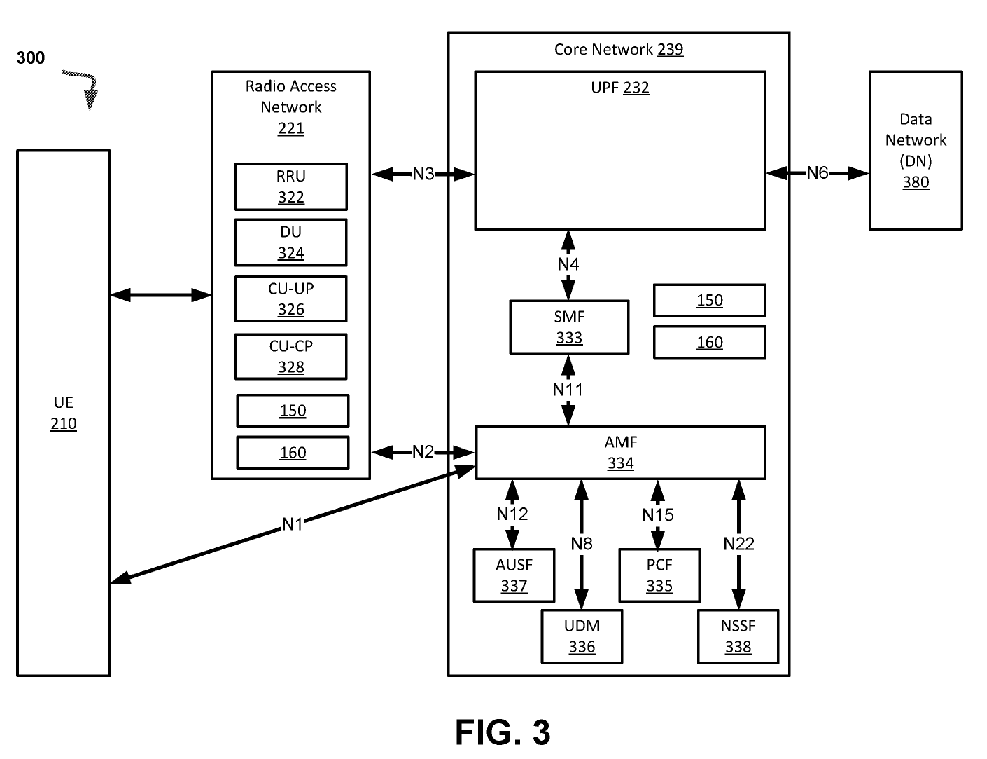

FIG. 3 illustrates a block diagram of example of a system 300, similar to system 100 of FIG. 1 and system 200 of FIG. 2, that includes a user authentication component that implements continuous user authentication using SIM and biometrics in the cellular network for the computing resource according to at least one embodiment.

Referring to FIGS. 2 and 3, the 5G network 220 connects user equipment (UE) 210 to the data network (DN) 380, and the DN 380 can include the Internet, a local area network (LAN), a wide area network (WAN), a private data network, a wireless network, a wired network, or a combination of networks. The UE 210 can include an electronic device with wireless connectivity or cellular communication capability, including mobile computing device such as a mobile phone or handheld computing device, and non-mobile computing device. In at least one example, the UE 210 can include a 5G smartphone or a 5G cellular device that connects to the RAN 221 via a wireless connection. As previously described, the RAN (e.g., RAN 221) may include an authentication component (e.g., the authentication component 150) and/or a computing resource (e.g., the computing resource 160). The UE 210 can include one of a number of UEs not depicted that are in communication with the RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

The RAN 221 includes a remote radio unit (RRU) 322 for wirelessly communicating with UE 210. The RRU 322 can include a Radio Unit (RU) and may include one or more radio transceivers for wirelessly communicating with UE 210. The RRU 322 may include circuitry for converting signals sent to and from an antenna of a Base Station into digital signals for transmission over packet networks. The RAN 221 may correspond with a 5G radio Base Station that connects user equipment to the core network 239. As previously described, the core network (e.g., core network 239) may include an authentication component (e.g., the authentication component 150) and/or a computing resource (e.g., the computing resource 160). The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210. The RAN 221 can include a new-generation radio access network (NG-RAN) that uses the 5G NR interface. In some embodiments, the distributed unit (DU) 324 and the centralized unit (CU) of the RAN 221 may be co-located with the RRU 322. In other embodiments, the DU 324 and the RRU 322 may be co-located at a cell site and the centralized unit (CU) may be located within a local data center (LDC). The DU 324 can include a logical node configured to provide functions for the radio link control (RLC) layer, the medium access control (MAC) layer, and the physical layer (PHY) layers. The centralized unit (CU) can be partitioned into a CU user plane portion (CU-UP) 326 and a CU control plane portion (CU-CP) 328. The CU-CP 328 may perform functions related to a control plane, such as connection setup, mobility, and security. The CU-UP 326 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 328 can include a logical node configured to provide functions of the control plane part of the RRC and PDCP. The centralized unit for the user plane(CU-UP) 326 can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol secure (HTTPS) with transport layer security (TLS) for encryption of traffic between network functions (NFs) and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 334, the session management function (SMF) 333, and the user plane function (UPF) 232. The AMF 334 may interface with UE 210, act as a single-entry point for a UE connection, and perform mobility management, registration management, and connection management between DN 380 and UE 210. The AMF 334 may interface with the SMF 333 to track user sessions. The AMF 334 may interface with a network slice selection function (NSSF) 338 to select network slice instances for user equipment. When user equipment is leaving a first coverage area and entering a second coverage area, the AMF 334 may be responsible for coordinating the handoff between the coverage areas whether the coverage areas are associated with the same radio access network or different radio access networks. The SMF 333 may perform session management, user plane selection, and Internet Protocol (IP) address allocation. After the Access Gateway Function (AGF) authenticates the subscriber and establishes a protocol data unit (PDU) session, the SMF 333 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the DN 380 to the UE 210, via the RAN 221 and/or transfer uplink data received from the UE 210 to the DN 380 via the RAN 221. An uplink can include a radio link though which UE 210 transmits data and/or control signals to the RAN 221. A downlink can include a radio link through which the RAN 221 transmits data and/or control signals to the UE 210.

Uplink packets arriving from the RAN 221 may use a general packet radio service (GPRS) tunneling protocol (or GTP) to reach the UPF 232. In certain scenarios, Internet Protocol Security (IPSec) may also be applied to secure this traffic. The GPRS tunneling protocol for the user plane may support multiplexing of traffic from different PDU sessions by tunneling user data over the interface N3 between the RAN 221 and the UPF 232. The UPF 232 may remove the packet headers belonging to the GTP tunnel before forwarding the user plane packets towards the DN 380. As the UPF 232 may provide connectivity towards other data networks in addition to the DN 380, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the DN 380 are mapped onto a specific quality of service (QoS) flow belonging to a specific PDU session before forwarded towards the appropriate RAN 221. A QoS flow may correspond with a stream of data packets that have equal QoS. The PDU session may utilize one or more QoS flows to exchange traffic (e.g., data and voice traffic) between the UE 210 and the DN 380. The one or more QoS flows can include the finest granularity of QoS differentiation within the PDU session. The PDU session may belong to a network slice instance through the 5G network 220. To establish user plane connectivity from the UE 210 to the DN 380, the AMF 334 that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) 335 for enforcing policy rules for control plane functions, an authentication server function (AUSF) 337 for authenticating user equipment and handling authentication related functionality, a network slice selection function (NSSF) 338 for selecting network slice instances, and an application function (AF) (not shown) for providing application services. Application-level session information may be exchanged between the AF and PCF 335 (e.g., bandwidth requirements for QoS). In some cases, when the UE 210 requests access to resources, such as establishing a PDU session or a QoS flow, the PCF 335 may dynamically decide if the UE 210 should grant the requested access based on a location of the UE 210.

The 5G network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the RAN 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

AMF 334 may be connected to SMF 333, PCF 335, UDM 336, AUSF 337, and NSSF 338 via different interfaces. AMF 334 may be connected to SMF 333 via an N11 interface. AMF 334 may be connected to PCF 335 via an N15 interface. AMF 334 may be connected to UDM 336 via an N8 interface. AMF 334 may be connected to AUSF 337 via an N12 interface. AMF 334 may be connected to NSSF 338 via an N22 interface. The RAN 221 may be connected to the AMF 334, which may allocate temporary unique identifiers, determine tracking areas, and select appropriate policy control functions (PCFs) for user equipment, via an N2 interface. The N2 interface may be used for transferring control plane signaling between the RAN 221 and the AMF 334. The UE 210 may be connected to the SMF 333 via an N1 interface, which may transfer UE information directly to the AMF 334 and an N11 interface. In addition, although not shown in FIG. 3, AMF 334 may be connected to evolved packet data gateway (ePDG), where ePDG can be connected through non-3Gpp based access network (e.g., untrusted WLANs) to UE 210, and therefore the interface includes multiple network connections.

The UPF 232 may be connected to the data network 380 via an N6 interface. The N6 interface may be used for providing connectivity between the UPF 232 and other external or internal data networks (e.g., to the Internet). In some cases, the data may not be tunneled across the N6 interface as IP packets may be routed based on end user IP addresses.

The UPF 232 may connect to the SMF 333 via the N4 interface. The N4 interface may be used for catering for a number of key session management procedures. The UPF 232 may receive, from SMF 333, via N4 interface, the necessary instructions in order to control and deliver the desired QoS. For example, the UPF 232 may identify and transport user plane traffic information and flow based on session management data received from the SMF 333. Each subscriber’s interaction with services (in other words, the traffic the user generates) can be described as a subscriber session, and since subscriber sessions may have different QoS requirements and the context that is required for each subscriber session is known and set, the SMF 333 may create, update and remove the contexts for subscriber sessions in the UPF 232. The SMF 333 does this via policy rules which, in turn, are obtained from the PCF 335 and other nodes and delivers to the UPF via the N4 interface.

The N3 Interface may be used for transferring user data (e.g., user plane traffic) from the RAN 221 to the UPF 232 and may be used for providing low-latency services using edge resources. The electrical distance from the UPF 232 (e.g., located at the edge of a network) to user equipment, such as UE 210, may impact the latency and performance services provided to the user equipment. The data may be tunneled across the N3 Interface (e.g., IP routing may be done on the tunnel header IP address instead of using end user IP addresses). This may allow for maintaining a stable IP anchor point even though UE 210 may be moving around a network of cells or moving from one coverage area into another coverage area.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application’s environment. In some embodiments, applications and services may be run using virtual machines instead of containers in order to improve security. A common virtual machine may also be used to run applications and/or containers for a number of closely related network services.

The 5G network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

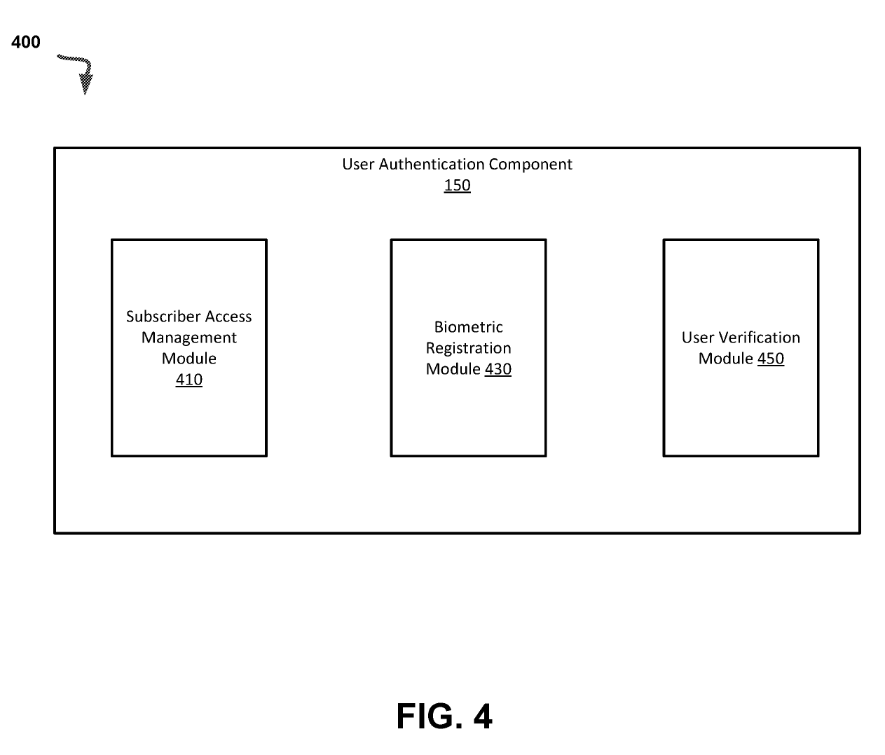

With reference to FIG. 4, the user authentication component 150 may include a subscriber access management module 410, a biometric registration module 430, and a user verification module 450.

The subscriber access management module 410 provisions, activates, and registers a SIM of the UE 210. In some embodiments, the subscriber access management module 410 is initiated in response to the UE 210 powering on with a new or existing SIM or a service activation request from a subscriber of the UE 210. The subscriber is an individual who owns the SIM, has a service contract with the CSP, and is authorized to use the network services through their associated subscription. Upon initiation, the subscriber access management module 410 provisions the SIM by associating its network identifier with a subscriber profile stored in the UDM, enabling backend authentication and policy enforcement. Once provisioning is complete, the subscriber access management module 410 activates the SIM by enabling assigned network services, such as voice, data, and messaging, based on the subscriber's service plan. Following activation, the subscriber access management module 410 manages the registration process, ensuring that the UE 210, via the SIM, successfully authenticates with the authentication server function (AUSF) and establishes a connection with the access and mobility management function (AMF). This registration allows the UE 210 to access network services, initiate and receive communications, and maintain continuous connectivity within the cellular network. In some embodiments, in response to provisioning, activation, and registration of the SIM of the UE 210, the biometric registration module 430 may prompt the subscriber to provide a representation of biometrics of the subscriber. The biometric registration module 430 may receive the representation of biometrics of the subscriber. As previously described, the UE 210 can capture biometrics using one or more sensors. The representation of biometrics of the subscriber may be, for example, a biometric hash. The UE 210 generates the biometric hash by processing raw biometric data through a template extraction algorithm that extracts key unique features from the raw biometric data (like fingerprint, face scan, etc.) and converts these features into a digital template. The digital template is then transformed into a standardized representation (e.g., the biometric hash) that can be used for matching.

The biometric registration module 430 associates the representation of biometrics of the subscriber to the SIM of the subscriber. In some embodiments, the biometric registration module 430 may update the subscriber profile stored in the UDM to associate the representation of biometrics of the subscriber to the SIM of the subscriber. Typically, during registration of the UE 210 to the network, the network assigns a session identifier to the UE 210 that map to a network identifier of the SIM of the subscriber. The biometric registration module 430 identifies, using the session identifier, the subscriber profile of the SIM of the subscriber via the UDM. The biometric registration module 430 updates the subscriber profile to include the representation of biometrics of the subscriber establishing a correlation between the representation of biometrics of the subscriber and the SIM of the subscriber. In some embodiments, operations of the subscriber access management module 410 and/or the biometric registration module 430 may be performed by a third party provider and hosted on the cellular network.

The user verification module 450 provides initial and continuous authentication of a current user of the UE 210. In response to receiving a request to access an application by a current user of the UE 210, the user verification module 450 provides initial authentication of the current user to the computing resource. In particular, the user verification module 450 receives, from the UE 210, the session identifier assigned to the UE 210 for its current network connection using the SIM. Additionally, the user verification module 450 receives a representation of biometrics of a current user of the UE 210 (e.g., a current representation of biometrics). The user verification module 450 identifies, using the session identifier, the subscriber profile of the SIM via the UDM. The user verification module 450 obtains the biometric hash associated with the subscriber profile (e.g., a stored representation of biometrics). The user verification module 450 compares the current representation of biometrics against the stored representation of biometrics. If the current representation of biometrics matches the stored representation of biometrics, the user verification module 450 notifies the computing resource that the current user has been authenticated as the subscriber of the SIM. Otherwise, the user verification module 450 notifies the computing resource that the current user has not been authenticated as the subscriber of the SIM. As a result, the current user is denied access to the computing resource. The user verification module 450 may receive a notification that the current user has been granted access and a user session is active (e.g., an active session).

In some embodiments, the user verification module 450 may provide, at predetermined intervals, reauthentication of the current user to the computing resource. Depending on the embodiment, the predetermined intervals may be configurable by the

In particular, in some embodiments, the user verification module 450 receives, from the UE 210, the session identifier and a new representation of biometrics of the current user of the UE 210 (e.g., a new representation of biometrics). Similar to the initial authentication, the user verification module 450 identifies, using the session identifier, the subscriber profile of the SIM via the UDM. The user verification module 450 obtains the stored representation of biometrics of a subscriber from the subscriber profile. The user verification module 450 compares the new representation of biometrics against the stored representation of biometrics. If the new representation of biometrics matches the stored representation of biometrics, the user verification module 450 notifies the computing resource that the current user is still authenticated as the subscriber of the SIM. The user verification module 450 may receive a notification, from the computing resource, that active session is maintained. Otherwise, the user verification module 450 notifies the computing resource that the current user is not the subscriber of the SIM. The user verification module 450 may receive a notification, from the computing resource, that active session is terminated. Depending on the embodiment, the user verification module 450 may not receive, from the UE 210, the new representation of biometrics. As a result, the user verification module 450 notifies the computing resource that there is no current user. The user verification module 450 may receive a notification, from the computing resource, that active session is terminated.

In some implementations, a system (e.g., system 100 in FIG. 1, system 200 in FIG. 2, or system 300 in FIG. 3) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, system 200 in FIG. 2, or system 300 in FIG. 3) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a user authentication component (e.g., the user authentication component 150 of FIGS. 1-4).

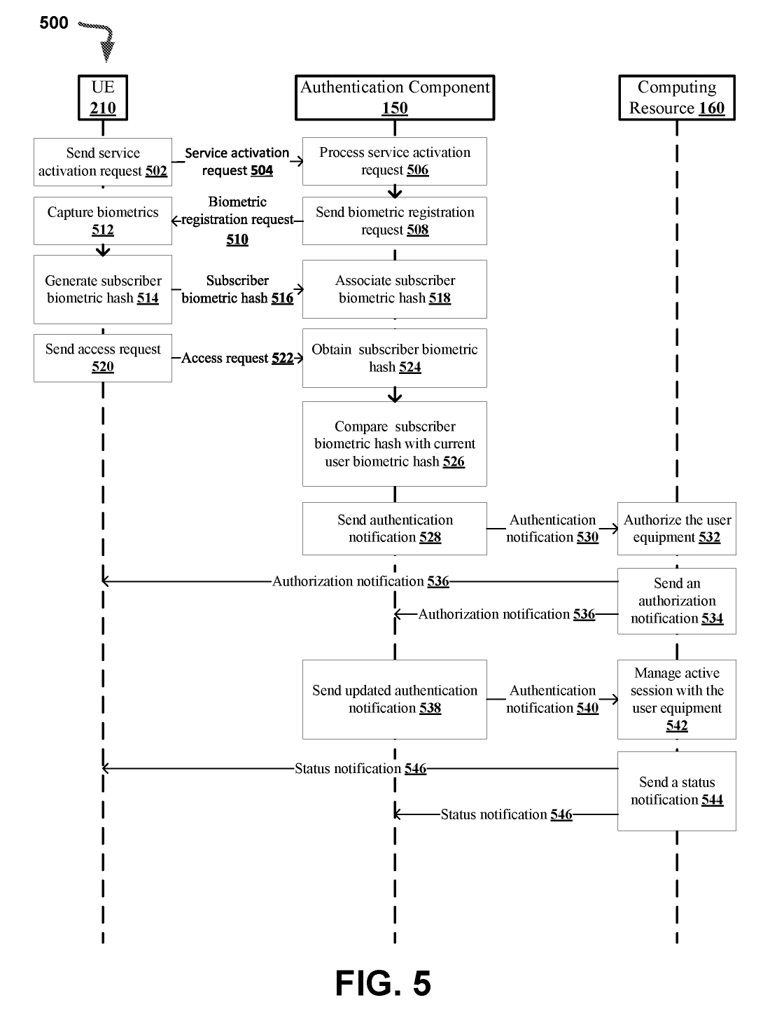

FIG. 5 is a sequence diagram illustrating a method 500 of implementing user authentication using SIM and biometrics in the cellular network for the application according to at least one embodiment.

In response to UE 210 being powering on for the first time, at block 502, the UE 210 sends a service activation request 504 to the authentication component 150. The service activation request 504 is a request to provision, activate, and register a SIM of UE 210. At block 506, the authentication component 150 processes the service activation request 504. In other words, provisions, activates, and registers the SIM of UE 210.

At block 508, the authentication component 150 sends a biometric registration request 510 to the UE 210. The biometric registration request 510 prompts a subscriber of the SIM to register their biometrics. At block 512, the UE 210 captures biometrics of the subscriber using one or more sensors of the UE 210. At block 514, the UE 210 generates a subscriber biometric hash 516 based on the captured biometrics of the subscriber. At block 518, the UE 210 provides the subscriber biometric hash 516 to the authentication component 150. At block 518, the authentication component 150 associates the subscriber biometric hash 516 to the SIM of the subscriber. The subscriber biometric hash 516 is associated to the SIM of the subscriber by storing in a subscriber profile for the SIM the subscriber biometric hash 516.

At block 520, the UE 210 sends an access request 522 to the authentication component 150 to access a computing resource 160. The access request 522 may be initiated by a current user (which may be the subscriber or an individual other than the subscriber) and include a unique identifier associated with the SIM (e.g., a temporary unique identifiers) and a current user biometric hash. The current user biometric hash is generated by capturing biometrics of a current user of UE 210.

At block 524, the authentication component 150 obtains a subscriber biometric hash 516 for the SIM by querying a subscriber profile for the SIM based on the unique identifier in the access request 522. At block 526, the authentication component 150 compares the subscriber biometric hash 516 for the SIM with the current user biometric hash. At block 528, the authentication component 150 sends an authentication notification 530 to the computing resources 160 based on the comparison. If the subscriber biometric hash 516 matches the current user biometric hash, the authentication notification 530 indicates that the current user of the UE 210 has been authenticated. If the subscriber biometric hash 516 does not match the current user biometric hash, the authentication notification 530 indicates that the current user of the UE 210 has not been authenticated.

At block 532, the computing resources 160 authorizes the UE 210 based on the authentication notification 530. At block 570, the computing resources 160 sends an authorization notification 534 to the computing resources 160 and/or the UE 210. If the authentication notification 530 indicates that the current user of the UE 210 has been authenticated, the authorization notification 534 indicates that access is granted, and an active session is established. If the authentication notification 530 indicates that the current user of the UE 210 has not been authenticated, the authorization notification 534 indicates that access is denied.

Every predetermined interval, at block 536, the authentication component 150 compares the subscriber biometric hash 516 with a recaptured current user biometric hash. Depending on the embodiment, the UE 210 may continuously provide the unique identifier and the recaptured current user biometric hash. The recaptured current user biometric hash is constantly generated by continuously capturing biometrics of a current user of the UE 210. Alternatively, the authentication component 150 at every predetermined interval sends a request to the UE 210 to provide the unique identifier and a recaptured current user biometric hash. Accordingly, the recaptured current user biometric hash is generated, in response to the request.

At block 538, the authentication component 150 sends an updated authentication notification 540 to the computing resources 160 based on the comparison. If the authentication component 150 is not provided a recaptured current user biometric hash to compare to the subscriber biometric hash 516, the comparison fails and the updated authentication notification 540 indicates that there is no current user to authenticate. If the subscriber biometric hash 516 matches the recaptured current user biometric hash, the updated authentication notification 540 indicates that the current user of the UE 210 has been re-authenticated. If the subscriber biometric hash 516 does not match the current user biometric hash, the updated authentication notification 540 indicates that the current user of the UE 210 is no longer authenticated.

At block 542, the computing resources 160 manages the active session based on the updated authentication notification 540. At block 544, the computing resources 160 sends a status notification 546 to the computing resources 160 and/or the UE 210. If the updated authentication notification 540 indicates that the current user of the UE 210 has been re-authenticated, the status notification 546 indicates that the active session is active (i.e., maintained). If the updated authentication notification 540 indicates that the current user of the UE 210 is no longer authenticated or there is no current user to authenticate, the status notification 546 indicates that the active session is terminated.

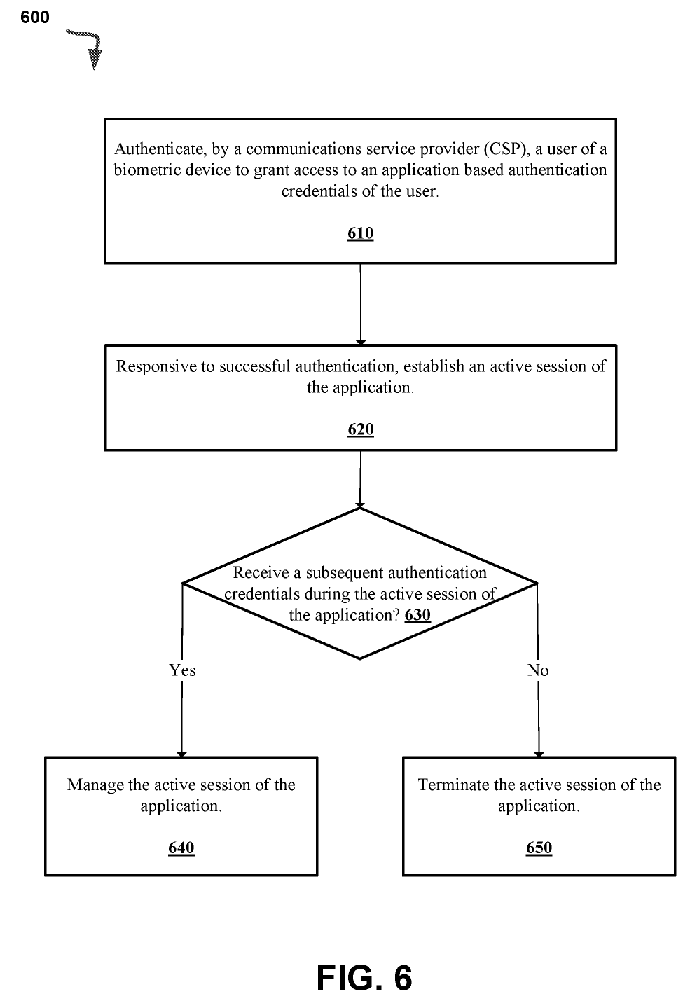

FIG. 6 is a flow diagram of a method 600 of implementing same-data multi-destination transmission by a reverse proxy for a cellular network according to at least one embodiment. The method 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 600 is performed by the system 100 of FIG. 1. In one embodiment, the method 600 is performed by the user authentication component 150 of FIGS. 1-4.

At operation 610, the processing logic authenticates, by a communications service provider (CSP) (e.g., a cellular network of the CSP), a user of a biometric device to grant access to an application based authentication credentials of the user. In some embodiments, the CSP may be a mobile network operator (MNO) or a mobile virtual network operator (MVNO). The authentication credentials may include a unique identifier of a subscriber identity module (SIM) of the biometric device and biometric data of the user. In some embodiments, the biometric device may be a mobile device, an augmented reality device, or a virtual reality device.

In some embodiments, to authenticate the user of the biometric device to grant access to the computing resource based authentication credentials of the user, the processing logic generates, based on the biometric data of the authentication credentials, a biometric hash. The generated biometric hash may be compared against a stored generated biometric hash associated with the SIM. Responsive to the generated biometric hash matching the stored biometric hash, the processing logic grants access to the computing resource. Responsive to the generated biometric hash not matching the stored biometric hash (i.e., unsuccessful authentication), the processing logic denies access to the computing resource.

At operation 620, the processing logic responsive to successful authentication, establishes an active session of the computing resource. At operation 630, the processing logic determines whether a subsequent authentication credentials is received during the active session of the computing resource.

If yes, at operation 640, the processing logic manages the active session of the computing resource. In some embodiments, to manage the active session of the computing resource, the processing logic generates, based on the biometric data of the subsequent authentication credentials, a biometric hash. The generated biometric hash may be compared against a stored generated biometric hash associated with the SIM. Responsive to the generated biometric hash matching the stored biometric hash, the processing logic maintains the active session of the computing resource. Responsive to the generated biometric hash not matching the stored biometric hash, the processing logic terminates the active session of the computing resource.

If no, at operation 650, the processing logic terminates the active session of the computing resource.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “authenticating,” “establishing,” “managing,” “generating,” “comparing,” “granting,” “denying,” “maintaining,” “terminating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
authenticating, by a cellular network at a first time, a user of a biometric device to grant access to a computing resource based on first authentication credentials of the user, wherein the first authentication credentials include a unique identifier of a subscriber identity module (SIM) of the biometric device and biometric data of the user;
responsive to successful authentication at the first time, establishing an active session of the computing resource with the biometric device; and
responsive to receiving second authentication credentials during the active session of the computing resource, verifying, by the cellular network at a second time, authentication of the user of the biometric device in the active session by determining whether the second authentication credentials comprises the unique identifier and the biometric data.

2. The method of claim 1, wherein successful authentication at the first time comprises:
generating, based on the biometric data of the first authentication credentials, a first biometric hash;
comparing the first biometric hash against a stored biometric hash associated with the SIM; and
responsive to the first biometric hash matching the stored biometric hash, granting access to the computing resource.

3. The method of claim 1, further comprising:
responsive to unsuccessful authentication at the first time, denying access to the computing resource.

4. The method of claim 1, wherein the biometric device is one of: a mobile device, an augmented reality device, or a virtual reality device.

5. The method of claim 1, wherein verifying authentication of the user of the biometric device in the active session comprises:
generating, based on the biometric data of the second authentication credentials, a second biometric hash;
comparing the second biometric hash against the biometric hash associated with the SIM; and
responsive to the second biometric hash matching the biometric hash associated with the SIM, maintaining the active session of the computing resource.

6. The method of claim 1, wherein verifying authentication of the user of the biometric device in the active session comprises:
generating, based on biometric data of the second authentication credentials, a second biometric hash;
comparing the second biometric hash against the biometric hash associated with the SIM; and
responsive to the second biometric hash not matching the biometric hash associated with the SIM, terminating the active session of the computing resource.

7. The method of claim 1, further comprising:
responsive to not receiving the second authentication credentials during the active session of the computing resource, terminating the active session of the computing resource.

8. The method of claim 1, wherein the cellular network is managed by one of: a mobile network operator (MNO) or a mobile virtual network operator (MVNO).

9. A computing system comprising:
one or more processing devices; and
memory communicatively coupled with and readable by the one or more processing devices and having stored therein processor-readable instructions which, when executed by the one or more processing devices, cause the one or more processing devices to perform operations comprising:
authenticating, by a cellular network at a first time, a user of a biometric device to grant access to a computing resource based on first authentication credentials of the user, wherein the first authentication credentials include a unique identifier of a subscriber identity module (SIM) of the biometric device and biometric data of the user;
responsive to successful authentication at the first time, establishing an active session of the computing resource with the biometric device; and
responsive to receiving second authentication credentials during the active session of the computing resource, verifying, by the cellular network at a second time, authentication of the user of the biometric device in the active session by determining whether the second authentication credentials comprises the unique identifier and the biometric data.

10. The computing system of claim 9, wherein successful authentication at the first time comprises:
generating, based on the biometric data of the first authentication credentials, a first biometric hash;
comparing the first biometric hash against a stored biometric hash associated with the SIM; and
responsive to the first biometric hash matching the stored biometric hash, granting access to the computing resource.

11. The computing system of claim 9, wherein the operations further comprise:
responsive to unsuccessful authentication at the first time, denying access to the computing resource.

12. The computing system of claim 9, wherein the biometric device is one of: a mobile device, an augmented reality device, or a virtual reality device.

13. The computing system of claim 9, wherein verifying authentication of the user of the biometric device in the active session comprises:
generating, based on the biometric data of the second authentication credentials, a second biometric hash;
comparing the second biometric hash against the biometric hash associated with the SIM; and
responsive to the second biometric hash matching the biometric hash, maintaining the active session of the computing resource.

14. The computing system of claim 9, wherein verifying authentication of the user of the biometric device in the active session comprises:
generating, based on biometric data of the second authentication credentials, a second biometric hash;
comparing the second biometric hash against the biometric hash associated with the SIM; and
responsive to the second biometric hash not matching the biometric hash associated with the SIM, terminating the active session of the computing resource.

15. The computing system of claim 9, wherein the operations further comprise:
responsive to not receiving the second authentication credentials during the active session of the computing resource, terminating the active session of the computing resource.

16. The computing system of claim 9, wherein the cellular network is managed by one of: a mobile network operator (MNO) or a mobile virtual network operator (MVNO).

17. One or more non-transitory, computer-readable storage media having computer-readable instructions thereon which, when executed by one or more processing devices, cause the one or more processing devices to perform operations comprising:
authenticating, by a cellular network at a first time, a user of a biometric device to grant access to a computing resource based on first authentication credentials of the user, wherein the first authentication credentials include a unique identifier of a subscriber identity module (SIM) of the biometric device and biometric data of the user;
responsive to successful authentication at the first time, establishing an active session of the computing resource with the biometric device; and
responsive to receiving second authentication credentials during the active session of the computing resource, verifying, by the cellular network at a second time, authentication of the user of the biometric device in the active session by determining whether the second authentication credentials comprise the unique identifier and the biometric data.

18. The one or more non-transitory, computer-readable storage media of claim 17, wherein successful authentication at the first time comprises:
generating, based on the biometric data of the first authentication credentials, a first biometric hash;
comparing the first biometric hash against a stored biometric hash associated with the SIM; and
responsive to the first biometric hash matching the stored biometric hash, granting access to the computing resource.

19. The one or more non-transitory, computer-readable storage media of claim 17, wherein verifying authentication of the user of the biometric device in the active session comprises:
generating, based on the biometric data of the second authentication credentials, a second biometric hash;
comparing the second biometric hash against the biometric hash associated with the SIM; and
responsive to the second biometric hash matching the biometric hash, maintaining the active session of the computing resource.

20. The one or more non-transitory, computer-readable storage media of claim 17, wherein verifying authentication of the user of the biometric device in the active session comprises:
generating, based on biometric data of the second authentication credentials, a second biometric hash;
comparing the second biometric hash against the biometric hash associated with the SIM; and
responsive to the second biometric hash not matching the biometric hash associated with the SIM, terminating the active session of the computing resource.
